(19) United States
(12) Patent Application Publication
(10) Pub. No.: US 2003/0141763 A1
(43) Pub. Date: Jul. 31, 2003

(54) Current regulator

(75) Inventors: Shawn Lance Tracy, Macomb, MI (US); Rafael Cobas Asensio, Zapopan (MX); Lou Vierling, Eastpointe, MI (US)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive, Inc.

(21) Appl. No.: 10/345,544

(22) Filed: Jan. 16, 2003

Related U.S. Application Data
(60) Provisional application No. 60/353,659, filed on Jan. 23, 2002.

(51) Int. Cl. H02J 1/04; H02J 7/34; H02J 3/10

(52) U.S. Cl. 307/60

(57) ABSTRACT

A current regulator that controls a load current by selectively connecting the load to a high voltage source and a low voltage source. The switching is triggered by a command pulse. By switching between the high voltage source and the low voltage source, the regulator controls load current without generating emissions. The low voltage source also maintains the load current at a selected level without requiring switching.

### REFERENCE TO RELATED APPLICATIONS

This application claims the benefit of U.S. Provisional Appln. No. 60/353,659, filed Jan. 23, 2002.

### TECHNICAL FIELD

The present invention relates to current regulators, and more particularly to a load current regulator that maintains a load current at a selected level with a signal that switches between a high level and a low level.

### BACKGROUND OF THE INVENTION

Many systems and devices, such as fuel injectors, rely on current regulators for controlling operation. Currently known current regulators for fuel injection systems regulate load current through an injector coil load by chopping (e.g., by a pulse width modulated (PWM) signal) to maintain the load current at a desired average level. As is known in the art, an injector coil in the fuel injection system is driven by current that is regulated by the PWM signal. To increase the current to a reference level, the PWM signal powers the injector coil by turning on a switch, such as FET switch, to connect the coil to a voltage source (e.g., a 48 V source) that is high enough to ensure a fast current rise time. When the load current reaches a predetermined level (e.g., 20 A), the PWM signal turns the switch off, shutting off current to the injector coil and allowing the current to fall until it reaches a lower threshold. This process is repeated as needed, causing the voltage level connected to the injector coil to switch between 48V and 0V via the PWM signal.

Regulators employing chopping, however, produce emissions each time the PWM signal transitions from high to low (e.g., on to off) and from low to high. Because regulators using PWM signals tend to transition frequently to obtain the desired average level, the generated emissions often reach undesirable levels that are difficult to reduce without affecting the operation of the regulator itself.

There is a desire for a system that can regulate load current without producing undesirable radio frequency emissions.

### SUMMARY OF THE INVENTION

The present invention is directed to a current regulator that controls a load current with two voltage sources having different values. In one embodiment, a first, high voltage source powers the load current at the current's rising and falling edges and a second, low voltage powers the load current while it is maintained at a selected reference level. The switching is triggered by a command pulse and by load current feedback. Together, the two voltage sources regulate the load current in a similar manner as a PWM signal. By using two voltage sources rather than a PWM signal, the inventive system avoids generating emissions normally associated with PWM signals. Further, by providing a low voltage source to maintain the load current, the inventive current regulator maintains the load current without requiring excessive switching.

### BRIEF DESCRIPTION OF THE DRAWINGS

FIG. 1 is a block diagram illustrating one embodiment of the invention;

FIG. 2 is a block diagram illustrating an embodiment of the invention in greater detail; and

FIG. 3 is a timing diagram illustrating the operation of components shown in FIG. 1.

### DETAILED DESCRIPTION OF THE EMBODIMENTS

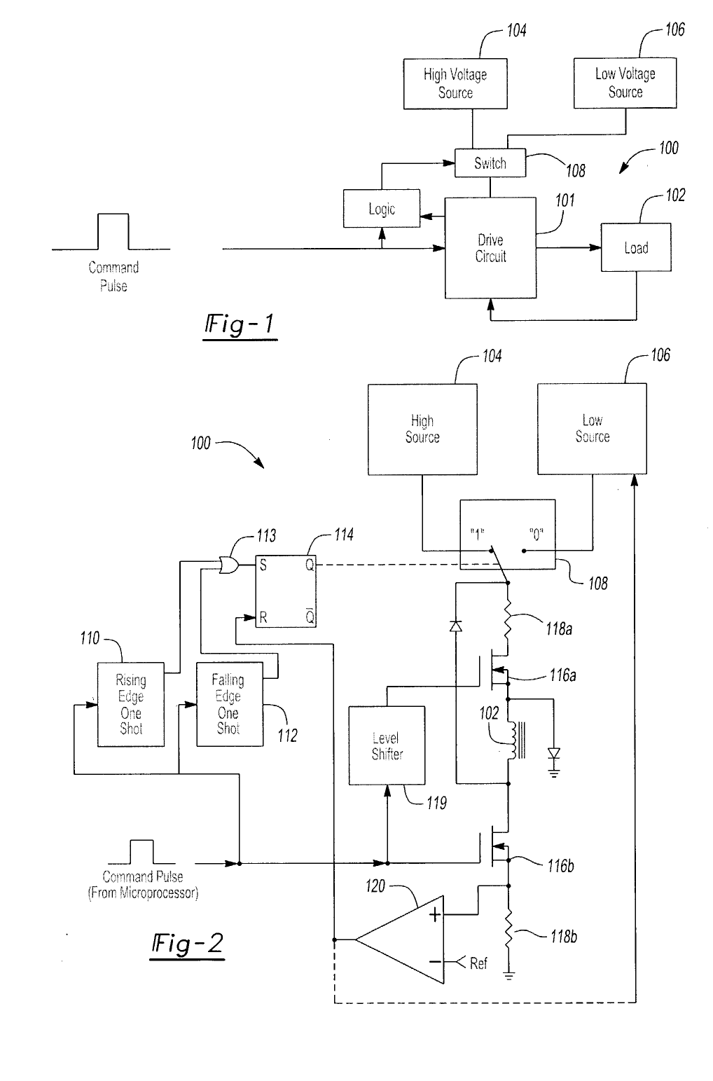

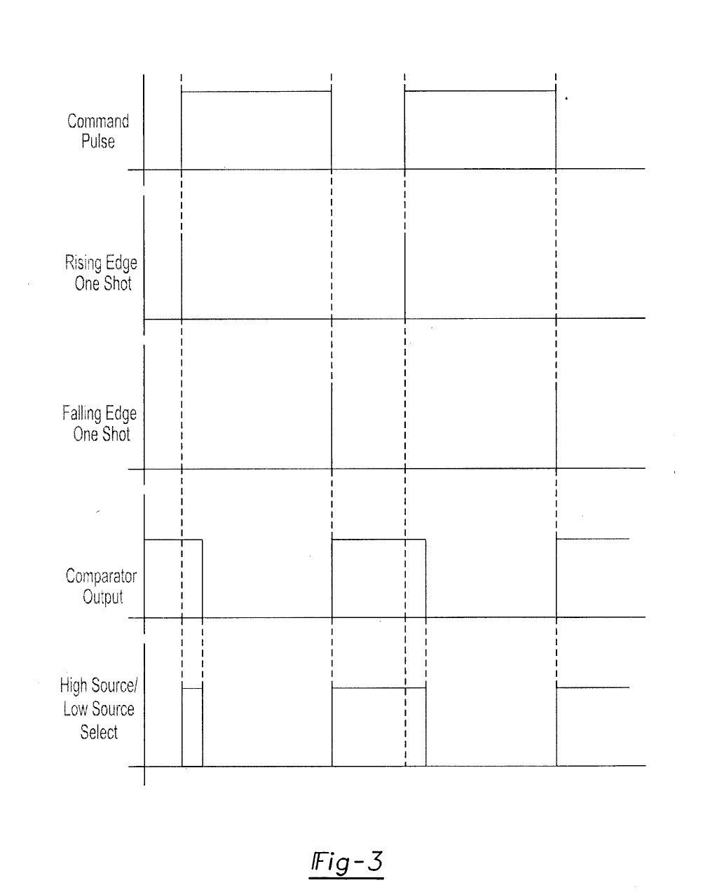

FIGS. 1 and 2 illustrates a current regulator 100 according to one embodiment of the invention, and FIG. 3 is a timing diagram illustrating an operation sequence of components in the regulator 100. FIG. 1 illustrates the broad concept of the invention, while FIG. 2 illustrates one embodiment of the invention in greater detail. The invention is generally directed to a system 100 that can control operation of any drive circuit 101 by controlling current through a load 102 with two voltage sources 104, 106 instead of a PWM signal. Although the example below focuses on a fuel injection system, the invention can be incorporated as a load current regulator for an inductive load in other contexts as well.

In this embodiment, a command pulse from a microprocessor (not shown) enters the regulator 100 to control the load current flow through a load 102. In this example, the load 102 is an injector coil that starts and stops fuel injection. The command pulse itself is controlled based on, for example, commands from an engine controller (not shown) that determine how much fuel is needed at any given instant.

Instead of relying on a PWM signal to control the current through the load, the inventive current regulator 100 has a high voltage source 104 and a low voltage source 106 that can be alternately connected into the current regulator 100 via a switch 108. The switch 108 will select one of the voltage sources 104, 106 at any given time based on the command pulse. In one embodiment, the high voltage source 104 has a value high enough to ensure that the current to the load 102 rises quickly to the reference level when it is selected, while the low voltage source 106 has a value to maintain the load current at a selected level. In general, the high voltage source 104 is selected at the rising edge of the command signal to raise the load current to the reference level and at the falling edge of the command signal to discharge the load current from the load 102 back to the high voltage source 104. The low voltage source 106 is selected when the desired load current has been achieved to maintain the load current at the reference level.

More particularly, with respect to FIGS. 1 through 3, the command pulse is sent to a rising edge one shot device 110, which responds to a rising edge of the command pulse, and a falling edge one shot device 112, which responds to a falling edge of the command pulse. When a rising edge in the command pulse triggers the rising edge one shot device 110, the rising edge one shot device 110 sends an output through an OR gate 113 into a flip-flop 114. The flip-flop 114 generates an output to any known control mechanism to cause the switch 108 to select the high voltage source 104, as shown in FIG. 2.

In this embodiment, high and low side switches 116a, 116b and high and low side shunts 118a, 118b connect the load 102 to the sources 104, 106. The high side switch 116a is controlled by a level shifter 119, which also receives the command pulse as an input. At this point, the command pulse turns on the low side switch 116b directly and turns on the high side switch 116a through the level shifter 119.

A comparator 120 monitors the load current and compares it with the reference level. In one embodiment, the comparator 120 is connected at the low side shunt 118b. As shown in FIG. 3, the comparator 120 output remains high as long as the load current remains below the reference level. When the load current reaches the reference level, the comparator 120 output goes low, resetting the flip-flop 114. When the flip-flop 114 is reset, the switch 108 is switched to select the low voltage source 106 to maintain the load current at the reference level.

The switch 108 continues to select the low voltage source 106 until the command pulse switches from high to low. At that point, the falling edge of the command pulse triggers the falling edge one shot device 112. The falling edge one shot device 112 sends an output through the OR gate 113 and sets the flip-flop 114. The flip-flop 114 causes the switch 108 to select the high voltage source 104.

When the command pulse goes from high to low, the command pulse directly turns off the low side switch 116b and turns off the high side switch 116a via the level shifter 119. This, in combination with connecting the high voltage source 104, causes current to recirculate through the load 102 quickly and back into the high voltage source 104, ensuring that the load current drops rapidly. To enable current recirculation, diodes 122a, 122b are connected on the high side and the low side, respectively, of the load 102.

Thus, by switching between the two voltage sources 112, 114, the output of the regulator maintains the load current at a selected level without any chopping. Further, by switching a high voltage source and a low voltage source instead of simply connecting and disconnecting a high voltage source, the invention allows the load current to be maintained at a selected level without excessive switching; the low voltage source acts as a load current maintenance device.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A current regulator that controls a load current through a load, comprising:
a first voltage source;
a second voltage source;
a switch that selectively connects the first voltage source and the second voltage source to the load; and
a drive circuit that receives a command signal and controls the switch based on the command signal, wherein the switch selects the first voltage source to change the load current and selects the second voltage source to maintain the load current.

2. The current regulator of claim 1, wherein the first voltage source has a first voltage level and the second voltage source has a second voltage level that is lower than the first voltage level.

3. The current regulator of claim 2, wherein the second voltage level is selected to maintain the load current at a reference current.

4. The current regulator of claim 1, wherein the drive circuit comprises:
a first device that triggers the switch to select the first voltage source at a transition edge of the command signal; and
a second device that causes the switch to select the second voltage source when a desired load current is achieved.

5. A current regulator that controls a load current through a load, comprising:
a high voltage source;
a low voltage source;
a comparator that compares the load current with a reference current and generates a comparator output;
a switch that selectively connects the high voltage source and the low voltage source to the load; and
a drive circuit that receives a command pulse and controls the switch based on the command signal and the comparator output, wherein the switch selects the high voltage source to change the load current and selects the low voltage source to maintain the load current.

6. The current regulator of claim 5, wherein the drive circuit comprises:
a rising edge device that is triggered by a rising edge of the command pulse; and
a falling edge device that is triggered by a falling edge of the command pulse, wherein the rising edge device and the falling edge device cause the switch to select the high voltage source when triggered.

7. The current regulator of claim 5, wherein the comparator output signal causes the switch to select the low voltage source when the load current is at the reference current.

8. The current regulator of claim 5, wherein the drive circuit further comprises at least one current discharge path that allows current to discharge from the load in response to the falling edge of the command pulse.

9. The current regulator of claim 9, further comprising at least one switch that opens and closes in response to the level shifter to form said at least one current discharge path for the load.

10. The current regulator of claim 8, wherein said at least one discharge path connects to the high voltage source to discharge the load current into the high voltage source.

11. A method for regulating a load current in a load, comprising:
receiving a command signal having a rising edge and a falling edge;
comparing the load current with a reference current in a comparator;
connecting the load to a high voltage source during at least one of the rising edge and the falling edge of the command signal; and
connecting the load to a low voltage source if the comparator indicates that the load current is equal to the reference current.

12. The method of claim 11, further comprising forming a discharge path in response to the falling edge of the command signal for discharging load current from the load.
